(19) United States
(12) Patent Application Publication
(10) Pub. No.: US 2026/0227674 A1
(43) Pub. Date: Aug. 6, 2026

(54) ULTRA-BRIGHT, NARROW LINEWIDTH PHOTON SOURCE FOR GENERATION OF ENTANGLED PHOTON PAIRS OR HERALDED SINGLE PHOTONS

(71) Applicant: Qunnect, Inc., Brooklyn, NY (US)

(72) Inventors: Alexander Craddock, Brooklyn, NY (US); Yang Wang, New York, NY (US); Felipe Giraldo, Mejia, NY (US); Rourke Sekelsky, Brooklyn, NY (US); Mael Flament, Brooklyn, NY (US); Mehdi Namazi, Brooklyn, NY (US)

(73) Assignee: Qunnect, Inc., Brooklyn, NY (US)

(21) Appl. No.: 19/152,376

(22) PCT Filed: Feb. 13, 2024
(86) PCT No.: PCT/US2024/015598

§ 371 Date: Jul. 30, 2025

Related U.S. Application Data
(60) Provisional application No. 63/484,709, filed on Feb. 13, 2023.

(51) Int. Cl. G02F 1/35

(52) U.S. Cl. CPC G02F 1/3526; G02F 1/3536

(57) ABSTRACT

Systems and methods for generating entangled photon pairs comprising two photons having different wavelengths are provided. The techniques include pumping an atomic vapor of an alkali atomic species with a pump laser and a coupling laser that are configured to drive a spontaneous four-wave mixing process within the atomic vapor. The pump laser and the coupling laser are detuned by large detunings relative to atomic transitions of the alkali atomic species, increasing brightness of the entangled pair photon source.

### CROSS REFERENCE TO RELATED APPLICATIONS

This application claims the benefit under 35 U.S.C. § 119 (e) to U.S. Provisional Application No. 63/484,709, filed Feb. 13, 2023, under Attorney Docket No. Q0074.70015US00, titled “ULTRA-BRIGHT, NARROW LINEWIDTH PHOTON SOURCE FOR GENERATION OF ENTANGLED PHOTON PAIRS OR HERALDED SINGLE PHOTONS,” which is incorporated herein by reference in its entirety.

### FEDERALLY SPONSORED RESEARCH

This invention was made with government support under DE-SC0021556 awarded by the Department of Energy. The government has certain rights in the invention.

### BACKGROUND

Quantum networks facilitate the transmission of information in the form of quantum bits (“qubits”) between physically separated quantum processors or other quantum devices (e.g., quantum sensors). Quantum networks may be used to enable optical quantum communication over distances and can be implemented over standard telecommunication optical fibers through the transmission of single photons onto which information is encoded (e.g., in polarization).

### SUMMARY

The following is a non-limiting summary of some embodiments of the present application. Some aspects of the present application are directed to a photon source, comprising an atomic vapor cell comprising atoms of an alkali atomic species. The atomic vapor cell is disposed in beam paths of a first laser beam and a second laser beam generated during operation of the photon source, and: the alkali atomic species comprises a first energy level, a second energy level, and a third energy level, wherein the second energy level is at a higher energy than the first energy level, and the third energy level is at a higher energy than the second energy level, and, during operation of the photon source: the first laser beam has a first wavelength configured with a first detuning relative to a first atomic transition in the alkali atomic species, the first atomic transition being between the first energy level and the second energy level, and the second laser beam has a second wavelength configured with a second detuning relative to a second atomic transition in the alkali atomic species, the second atomic transition being between the second and third energy levels, and the second detuning being based at least in part on the first detuning.

In some embodiments, during operation of the photon source, the first laser beam is arranged to be co-propagating with the second laser beam through the atomic vapor cell.

In some embodiments, the first wavelength and the second wavelength have values configured to satisfy conditions for a four-wave mixing process in the alkali atomic species.

In some embodiments, the first detuning is greater than a one-photon resonant Doppler broadening of the alkali atomic species and less than or equal to 2π×10 GHz.

In some embodiments, the first detuning is approximately 2π×1 GHz.

In some embodiments, the first detuning is approximately 2π×1.1 GHz.

In some embodiments, the first detuning is approximately 2π×1.15 GHz.

In some embodiments, the first energy level is a |5S_{1/2} [symbol] state, the second energy level is a |5P_{3/2} [symbol] state, and the third energy level is a |6S_{1/2} [symbol] state.

In some embodiments, the first wavelength is approximately 780 nm.

In some embodiments, the second detuning is a two-photon detuning that is larger than a double-resonant Doppler broadening of the alkali atomic species and less than or equal to 2π×10 GHz.

In some embodiments, the second detuning is approximately 2π×2 GHz.

In some embodiments, the second detuning is approximately 2π×2.4 GHz.

In some embodiments, the second wavelength is approximately 1367 nm.

In some embodiments, the first laser beam and/or the second laser beam are operated with a power of approximately 5 mW.

In some embodiments, the first laser beam and/or the second laser beam are operated with a beam diameter of approximately 50 μm.

In some embodiments, during operation of the photon source, the atomic vapor cell is configured to output bichromatic entangled pairs of photons.

In some embodiments, the bichromatic entangled pairs of photons each comprise a first photon and a second photon, wherein the first photon and the second photon have different wavelengths.

In some embodiments, the first photon has a wavelength compatible with telecommunications technology.

In some embodiments, the first photon has a wavelength in a range from 1300 nm to 1600 nm.

In some embodiments, the first photon has a wavelength that is approximately 1324 nm.

In some embodiments, the first photon has a wavelength that is approximately 1324 nm, 1367 nm, 1476 nm, or 1529 nm.

In some embodiments, the second photon has a near-infrared (NIR) wavelength.

In some embodiments, the second photon has a wavelength in a range from 700 nm to 925 nm.

In some embodiments, the second photon has a wavelength of approximately 795 nm.

In some embodiments, the second photon has a wavelength of approximately 795 nm or 780 nm.

In some embodiments, the photon source further comprises a first output and a second output, each optically coupled to outputs of the atomic vapor cell such that the first photon exits the photon source from the first output and the second photon exits the photon source from the second output.

In some embodiments, the photon source further comprises a single photon detector optically coupled to either the first output or the second output.

In some embodiments, the photon source further comprises a Fabry-Perót etalon optically coupled between an output of the atomic vapor cell and the first output; and a single photon detector optically coupled to the second output.

In some embodiments, the photon source further comprises a band-pass filter optically coupled between an output of the atomic vapor cell and the first and/or second outputs.

In some embodiments, the photon source further comprises a liquid crystal retardation plate optically coupled between an output of the atomic vapor cell and the second output.

In some embodiments, the photon source further comprises a first laser source configured to generate the first laser beam; and a second laser source configured to generate the second laser beam.

In some embodiments, the alkali atomic species comprises rubidium.

Some aspects of the present application are directed to a method of generating an entangled pair of photons from an atomic vapor cell comprising atoms of an alkali atomic species, the alkali atomic species comprising a first energy level, a second energy level having a higher energy than the first energy level, and a third energy level having a higher energy than the second energy level. The method comprises: generating a first laser beam using a first laser, the first laser beam having a first wavelength configured with a first detuning relative to a first atomic transition in the alkali atomic species, the first atomic transition being between the first energy level and the second energy level; generating a second laser beam using a second laser, wherein the second laser beam has a second wavelength configured with a second detuning relative to a second atomic transition in the alkali atomic species, the second atomic transition being between the second and third energy levels, and the second detuning being based at least in part on the first detuning; causing, by steering the first and second laser beams through a same region of the atomic vapor cell, a four-wave mixing process in the atoms; and generating, as a result of the four-wave mixing process, the entangled pair of photons.

In some embodiments, steering the first and second laser beams through the same region of the atomic vapor cell comprises causing the first and second laser beams to be co-propagating through the atomic vapor cell.

In some embodiments, generating the first laser beam comprises generating the first laser beam with a first wavelength configured with a first detuning that is greater than a one-photon resonant Doppler broadening of the alkali atomic species and less than or equal to 2π×10 GHz.

In some embodiments, generating the first laser beam comprises generating the first laser beam with a first wavelength configured with a first detuning of approximately 2π×1 GHz.

In some embodiments, generating the first laser beam comprises generating the first laser beam with a first wavelength configured with a first detuning of approximately 2π×1.1 GHz.

In some embodiments, generating the first laser beam comprises generating the first laser beam with a first wavelength configured with a first detuning of approximately 2π×1.15 GHz.

In some embodiments, the first energy level is a |5S_{1/2} [symbol] state, the second energy level is a |5P_{3/2} [symbol] state, and the third energy level is a |6S_{1/2} [symbol] state.

In some embodiments, generating the first laser beam having the first wavelength comprises generating the first laser beam with a first wavelength of approximately 780 nm.

In some embodiments, generating the second laser beam comprises generating the second laser beam with a second wavelength configured with a second detuning that is a two-photon detuning and is larger than a double-resonant Doppler broadening of the alkali atomic species and less than or equal to 2π×10 GHz.

In some embodiments, generating the second laser beam comprises generating the second laser beam with a second wavelength configured with a second detuning of approximately 2π×2 GHz.

In some embodiments, generating the second laser beam comprises generating the second laser beam with a second wavelength configured with a second detuning of approximately 2π×2.4 GHz.

In some embodiments, generating the second laser beam comprises generating the second laser beam with a second wavelength of approximately 1367 nm.

In some embodiments, generating the first laser beam and/or generating the second laser beam comprises generating a laser beam having a power of approximately 5 mW.

In some embodiments, generating the first laser beam and/or generating the second laser beam comprises generating a laser beam having a beam diameter of approximately 50 μm.

In some embodiments, causing the four-wave mixing process in the atoms causes the atomic vapor cell to output bichromatic entangled pairs of photons.

In some embodiments, the bichromatic entangled pairs of photons each comprise a first photon and a second photon, wherein the first photon and the second photon have different wavelengths.

In some embodiments, the first photon has a wavelength compatible with telecommunications technology.

In some embodiments, the first photon has a wavelength in a range from 1300 nm to 1600 nm.

In some embodiments, the first photon has a wavelength that is approximately 1324 nm.

In some embodiments, the first photon has a wavelength that is approximately 1324 nm, 1367 nm, 1479 nm, or 1529 nm.

In some embodiments, the second photon has a near-infrared (NIR) wavelength.

In some embodiments, the second photon has a wavelength in a range from 700 nm to 925 nm.

In some embodiments, the second photon has a wavelength of approximately 795 nm. In some embodiments, the second photon has a wavelength of approximately 795 nm or 780 nm.

In some embodiments, the method further comprises detecting the second photon using a single photon detector such that first photon is output as a heralded single photon.

In some embodiments, the method further comprises filtering the first photon using a Fabry-Perót etalon.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a photon source 100, in accordance with some embodiments of the technology described herein.

FIG. 2 is an illustrating energy level diagram for rubidium, in accordance with some embodiments of the technology described herein.

FIG. 3 is a schematic diagram of a photon source 300 configured for rack-mounting, in accordance with some embodiments of the technology described herein.

FIG. 4 is a heatmap of heralding efficiency as a function of vapor cell temperature and two-photon detuning, in accordance with some embodiments of the technology described herein.

FIG. 5A is a plot showing simulated unweighted scattering probabilities as a function of atomic velocities when the pump detuning is near resonance and far from resonance, in accordance with some embodiments of the technology described herein.

FIG. 5B is a plot showing simulated, weighted scattering probabilities as a function of atomic velocities when the pump detuning is near resonance and far from resonance, in accordance with some embodiments of the technology described herein.

FIG. 6A is a plot showing measured signal-idler coincidence rates as a function of coupling power for various pump powers, in accordance with some embodiments of the technology described herein.

FIG. 6B is a plot showing measured maximum values of signal-idler cross-correlation as a function of the coincidence rate, in accordance with some embodiments of the technology described herein.

FIG. 7A is a diagram showing real parts of the maximum-likelihood density matrix reconstruction of the signal-idler state, in accordance with some embodiments of the technology described herein.

FIG. 7B is a diagram showing imaginary parts of the maximum-likelihood density matrix reconstruction of the signal-idler state, in accordance with some embodiments of the technology described herein.

FIG. 8A is a schematic diagram of a heralded single photon source 800a, in accordance with some embodiments of the technology described herein.

FIG. 8B is a schematic diagram of a heralded single photon source 800b, in accordance with some embodiments of the technology described herein.

FIG. 9A is a schematic diagram of a heralded single photon source 900, in accordance with some embodiments of the technology described herein.

FIG. 9B is a plot showing measured heralding efficiencies as a function of etalon frequency, in accordance with some embodiments of the technology described herein.

FIG. 10 is a flowchart describing a process 1000 of generated an entangled pair of photons, in accordance with some embodiments of the technology described herein.

### DETAILED DESCRIPTION

Described herein are techniques for generating bright entangled photon pairs and/or heralded single photons using a photon source. These techniques include the use of two pump laser beams that have large detunings relative to two atomic transitions of an atomic species used to form an atomic vapor. The two pump laser beams interact with atoms of the atomic vapor and, through a four-wave mixing process, cause the generation of entangled photon pairs having two wavelengths to be emitted from the atomic vapor cell. The entangled photon pairs may then be used for various applications, including transmission of quantum information. Alternatively, the photon source may act as a heralded single photon source by the inclusion of a detector configured to detect one photon of the generated entangled photon pairs.

Quantum communication leverages the special properties of quantum mechanics in order to exponentially enhance encoding, processing and transferring information. Whether the end goal is connecting quantum computers, performing ultra-precise sensing measurements, or creating quantum-secured communication networks, all would rely on the connection of heterogeneous quantum devices. Such devices are often not intrinsically, communicatively compatible; for example, they may operate using different frequencies or spatial modes (e.g., transmitting over free space or optical fiber). For example, atomic magnetometers (AMs) use rubidium (Rb) atoms to measure magnetic fields with sensitivities better than 10fT/\sqrt{Hz} by detecting the change in the polarization state of the magnetic fields interacting with the Rb atoms. Networking an array of AMs with a polarization-entangled photon source would be desirable for improving measurement sensitivity, similar to what has been proposed for a long-baseline telescope based on a quantum repeater. Many applications require multiple sensors that work jointly to tackle distributed sensing problems.

However, this realization still remains elusive as AMs and other atomic-based sensors typically operate at wavelengths of approximately 780-795 nm instead of 1300 nm and/or 1550 nm which are commonly used for optical fiber communication. The same challenge is also faced for room temperature quantum memories using rubidium atoms and many other atomic technologies such as quantum simulators and photonic phase modulators. The communication between quantum devices is even further complicated as quantum technology transitions from static to mobile quantum devices (e.g., aero- or naval quantum nodes). To connect these mobile nodes to each other efficiently, photons with near-infrared (NIR) wavelengths (780-795 nm) have been shown to experience reduced atmospheric loss and disturbances compared to photons at optical fiber-compatible wavelengths (e.g., infrared wavelengths). There exists a significant and unmet need for devices which enable cross-device frequency compatibility in quantum-secure networks.

The inventors have recognized that pairs of atomic transitions in certain atomic species may be used to generate corresponding entangled pairs of photons at telecom and free space communication wavelengths. Accordingly, the inventors have developed a photon source using warm atomic vapors of alkali atomic species (e.g., rubidium, cesium, or other suitable alkali atomic species). The generated entangled photon pairs include photons that are entangled in the polarization space, but each photon of the entangled photon pairs has a different wavelength. For example, one photon of the entangled photon pair may have a near-infrared (NIR) wavelength while the other photon has an infrared wavelength (e.g., compatible with telecommunications applications). The photon source utilizes the process of spontaneous four-wave mixing (SFWM) in a warm atomic vapor cell to convert the photons from two classical pump fields (e.g., from a first and second pump laser) into pairs of single photons at two different wavelengths yet entangled with one another. The photon source may use, for example, the atomic transitions of a well-characterized rubidium vapor to access a wide range of wavelengths, including telecom O, S, and C bands for fiber transmission and NIR for quantum buffering, processing, and sensing.

The inventors have further recognized that detuning the first and second pump lasers from atomic transitions of the alkali atomic species by large detuning values can increase the brightness of the photon source (e.g., by a factor of 1000). In some embodiments, the first pump laser, providing the pump field, is detuned from a first atomic transition (e.g., between a first excited state to a second excited state) of the alkali atomic species by a large one-photon detuning. For example, the detuning of the first pump laser may be greater than the resonant Doppler broadening of the alkali atomic species (e.g., approximately equal to or greater than 2π×1 GHz, 2π×1.1 GHz, or 2π×1.15 GHz and less than or equal to 2π×10 GHz). The second pump laser, providing the coupling field, is detuned from a second atomic transition (e.g., between a second excited state and a third excited state) by a large two-photon detuning. For example, the detuning of the second pump laser may be greater than the double-resonant Doppler broadening of the alkali atomic species (e.g., approximately equal to or greater than 2π×2 GHz or 2π×2.4 GHz and less than or equal to 2π×10 GHz).

Typically, such a large wavelength difference between pump and coupling fields results in the provided laser beams being limited to a relatively small velocity class of atoms in the atomic vapor, thereby resulting in few generated entangled photon pairs and brightnesses ranging from approximately 5×10³ s⁻¹ to approximately 8×10⁵ s⁻¹. However, the inventors further recognized and appreciated that the photon pair generation rate may be increased by reducing the interaction area (e.g., by reducing a beam diameter of the pump lasers to, for example, 50 μm), thereby increasing the intensity of the pump lasers without increasing the input power of the pump laser beams, which may be maintained at a relatively low power (e.g., 5 mW). Accordingly, the inventors developed a one-to-one telescope design, with the atomic vapor cell disposed at the telescope's center, to reduce the beam diameter.

Additionally, the inventors recognized that aligning the pump laser beams so that they co-propagate through the atomic vapor cell further increases the effective interaction volume between atoms of the atomic vapor and the pump lasers, further improving the photon pair generation rate to be on the order of 10⁷ s⁻¹ with a lower bound on the |φ₊ [symbol] Bell state fidelity of greater than 95%. Finally, the inventors recognized and appreciated that photons generated by the photon source as described herein are output with wavelengths that are significantly different from the wavelengths of the pump lasers such that off-the-shelf optical components may be used to filter the generated photon pairs from the pump photons, thereby reducing manufacturing costs and decreases manufacturing time caused by long lead times for the manufacturing of specialized optical equipment.

### I. Entangled Photon Source

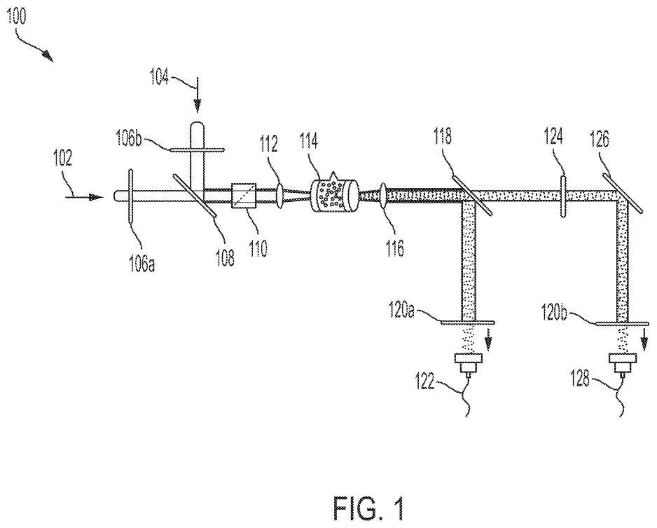

FIG. 1 is a schematic diagram of a photon source 100, in accordance with some embodiments of the technology described herein. The photon source 100 is configured to receive (e.g., through suitable input ports) a first laser beam 102 and second laser beam 104. The first laser beam 102 and the second laser beam 104 may have respective different wavelengths. For example, the first laser beam 102 and the second laser beam 104 may have wavelengths configured with detunings relative to first and second atomic transitions of atoms in an atomic vapor stored within an atomic vapor cell 114 located within a beam path of the first and second laser beams 102, 104.

In some embodiments, the first and second laser beams 102, 104 may be optically coupled to the atomic vapor cell 114 by one or more optical components. As shown in the example of FIG. 1, the first laser beam 102 and the second laser beam 104 may each pass through a bandpass filter 106a, 106b. Thereafter, the first laser beam 102 and the second laser beam 104 may be combined by a dichroic mirror 108 such that the first laser beam 102 and the second laser beam 104 are co-propagating along a same beam path. The co-propagating laser beams 102, 104 may then pass through a polarizing beamsplitter 110 and a lens 112. The polarizing beamsplitter 110 may be configured to cause both the first laser beam 102 and the second laser beam 104 to be horizontally polarized.

In some embodiments, the lens 112 may be configured to reduce a beam diameter of the co-propagating laser beams 102, 104. For example, the lens 112 may be an achromatic lens with f≈50 mm configured to focus the beam diameter of the co-propagating laser beams 102, 104 to a 1/e² beam diameter of approximately 20-50 μm. It should be appreciated that, in some alternative embodiments, optical components between the input ports of the photon source 100 and the atomic vapor cell 114 may be disposed in an alternative arrangement (e.g., polarizing beamsplitter 110 may be removed, and alternative polarizing beamsplitters may be disposed between the bandpass filters 106a, 106b and the dichroic mirror 108), as aspects of this technology are not limited in this respect.

In some embodiments, the atomic vapor cell 114 includes a housing supporting a magneto-optical trap configured to confine atoms of the atomic vapor within the atomic vapor cell 114. The housing of the atomic vapor cell 114 may be hermetically sealed to prevent contamination and may include one or more optically transparent windows to allow light to enter and/or exit the atomic vapor cell 114. The atomic vapor cell 114 may have a length on the order of several millimeters (e.g., 5 mm). The atomic vapor cell 114 may be configured to confine a warm atomic vapor or a cold atomic cold, in some embodiments. In embodiments in which the atomic vapor cell 114 is configured to confine a warm atomic vapor, the atomic vapor cell 114 may be heated by one or more ceramic heaters thermally coupled to the atomic vapor cell 114. In some embodiments, the atomic vapor cell 114 may be surrounded by shielding (e.g., comprising mu-metal) to prevent magnetic and/or electric fields from affecting the atomic vapor within the atomic vapor cell 114.

In some embodiments, atomic vapor cell 114 may contain an atomic vapor comprising atoms that may, upon receipt of pump fields (e.g., laser beams) absorb received photons of certain frequencies, go through a two-stage excitation and decay process, and re-emit photons having entangled polarization states. For example, atomic vapor cell 114 may contain an atomic vapor of rubidium (e.g., ⁸⁷Rb, ⁸⁵Rb, or any other suitable isotope). Alternatively, in some embodiments, atomic vapor cell 114 may contain an atomic vapor of another alkali metal. For example, the alkali metal may include isotopes of cesium (e.g., ¹³³Cs, or any other suitable isotope).

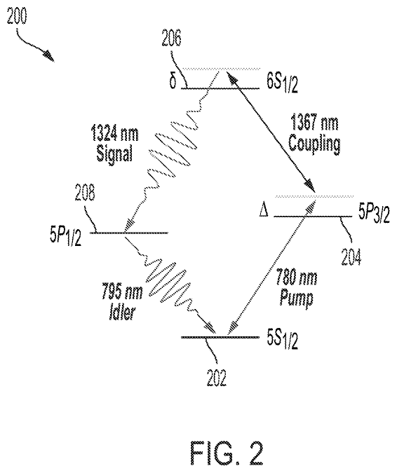

In some embodiments, the atomic vapor may exhibit a two-photon resonance that permits generation of entangled photon pairs at two desired wavelengths. For example, as shown in FIG. 2, ⁸⁷Rb exhibits a two-photon resonance (or four-wave mixing process) along the transitions |5S_{1/2} [symbol] →|5P_{3/2} [symbol] →|6S_{1/2} [symbol] which can generate entangled photons having wavelengths of approximately 795 nm and approximately 1324 nm in response to excitation by received light having wavelengths of approximately 780 nm and approximately 1367 nm. Alternatively or additionally, a two-photon resonance in an ⁸⁷Rb vapor may be used to generate photon pairs having wavelengths of approximately 1367 nm and 780 nm, 1476 nm and 795 nm, and/or 1529 nm and 780 nm, providing a flexible photon source that may be used to generate a spectrum of wavelengths in the NIR, O, C, and/or S bands. These particular bands have a wide range of applications across quantum communications and computation. For example, the wavelengths 1324 nm, 1476 nm, and 1529 nm each respectively correspond to O, S, and C telecom bands, and are suitable wavelengths for optical fiber communications over large distances. Additionally, the wavelengths 795 nm and 780 nm are commonly used for quantum buffers and sensors.

This illustrative transition cycle offers few pathways for photons to spontaneously decay to the ground state, providing a higher rate of entanglement and fewer output uncorrelated photons. It should be appreciated that other similar two-photon resonances may exist in other isotopes of rubidium or other atomic systems. As additional examples, potential wavelengths of photon pairs that may be generated in ⁸⁷Rb and ¹³³Cs systems are provided in Tables 1 and 2, respectively. These additional illustrative wavelengths may be used to interface with some Rydberg and ion technologies such as neutral quantum computers and sensors.

TABLE 1
Wavelengths of photon pairs that can be generated from atomic transitions in ⁸⁷Rb.

| | Transitions between the | | Transitions between the | | Transitions between the | | Transitions between the | |
|---|---|---|---|---|---|---|---|---|
| | D₁ line and nS states | | D₂ line and nS states | | D₁ line and nD_{3/2} states | | D₂ line and nD_{3/2} states | |
| | First | Second | First | Second | First | Second | First | Second |
| | Wavelength | Wavelength | Wavelength | Wavelength | Wavelength | Wavelength | Wavelength | Wavelength |
| n | (nm) | (nm) | (nm) | (nm) | (nm) | (nm) | (nm) | (nm) |
| 4 | | | | | 1475.64 | | 1529.26 | |
| 5 | | | | | 1475.64 | 762.10 | 1529.26 | 776.16 |
| 6 | 1323.88 | | 1366.87 | | 1475.64 | 620.80 | 1529.26 | 630.10 |
| 7 | 1323.88 | 728.20 | 1366.87 | 741.02 | 1475.64 | 564.93 | 1529.26 | 572.62 |
| 8 | 1323.88 | 607.23 | 1366.87 | 616.12 | 1475.64 | 536.42 | 1529.26 | 543.35 |
| 9 | 1323.88 | 558.03 | 1366.87 | 565.53 | 1475.64 | 519.68 | 1529.26 | 526.17 |
| 10 | 1323.88 | 532.38 | 1366.87 | 539.21 | 1475.64 | 508.94 | 1529.26 | 515.17 |
| 11 | 1323.88 | 517.11 | 1366.87 | 523.54 | 1475.64 | 501.62 | 1529.26 | 507.67 |
| 12 | 1323.88 | 507.20 | 1366.87 | 513.39 | 1475.64 | 496.38 | 1529.26 | 502.31 |
| 13 | 1323.88 | 500.38 | 1366.87 | 506.40 | 1475.64 | 492.51 | 1529.26 | 498.34 |
| 14 | 1323.88 | 495.47 | 1366.87 | 501.38 | 1475.64 | 489.56 | 1529.26 | 495.32 |
| 15 | 1323.88 | 491.82 | 1366.87 | 497.63 | 1475.64 | 487.25 | 1529.26 | 492.96 |
| 16 | 1323.88 | 489.02 | 1366.87 | 494.77 | 1475.64 | 485.42 | 1529.26 | 491.08 |
| 17 | 1323.88 | 486.83 | 1366.87 | 492.52 | 1475.64 | 483.93 | 1529.26 | 489.56 |
| 18 | 1323.88 | 485.073 | 1366.87 | 490.73 | 1475.64 | 482.71 | 1529.26 | 488.31 |
| 19 | 1323.88 | 483.65 | 1366.87 | 489.27 | 1475.64 | 481.70 | 1529.26 | 487.28 |
| 20 | 1323.88 | 482.48 | 1366.87 | 488.08 | 1475.64 | 480.85 | 1529.26 | 486.41 |
| n → ∞ | 1323.88 | 474 | 1366.87 | 479 | 1475.64 | 474 | 1529.26 | 479 |

TABLE 2
Wavelengths of photon pairs that can be generated from atomic transitions in ¹³³Cs.

| | Transitions between the | | Transitions between the | | Transitions between the | | Transitions between the | |
|---|---|---|---|---|---|---|---|---|
| | D₁ line and nS states | | D₂ line and nS states | | D₁ line and nD_{3/2} states | | D₂ line and nD_{3/2} states | |
| | First | Second | First | Second | First | Second | First | Second |
| | Wavelength | Wavelength | Wavelength | Wavelength | Wavelength | Wavelength | Wavelength | Wavelength |
| n | (nm) | (nm) | (nm) | (nm) | (nm) | (nm) | (nm) | (nm) |
| 5 | | | | | 3011.15 | | 3614.09 | |
| 6 | | | | | 3011.15 | 876.38 | 3614.09 | 921.11 |
| 7 | 1359.20 | | 1469.89 | | 3011.15 | 672.51 | 3614.09 | 698.54 |
| 8 | 1359.20 | 761.10 | 1469.89 | 794.61 | 3011.15 | 601.22 | 3614.09 | 621.93 |
| 9 | 1359.20 | 635.63 | 1469.89 | 658.83 | 3011.15 | 566.56 | 3614.09 | 584.92 |
| 10 | 1359.20 | 584.05 | 1469.89 | 603.58 | 3011.15 | 546.75 | 3614.09 | 563.83 |
| 11 | 1359.20 | 557.00 | 1469.89 | 574.73 | 3011.15 | 534.24 | 3614.09 | 550.54 |
| 12 | 1359.20 | 540.82 | 1469.89 | 557.52 | 3011.15 | 525.80 | 3614.09 | 541.58 |
| 13 | 1359.20 | 530.29 | 1469.89 | 546.34 | 3011.15 | 519.82 | 3614.09 | 535.23 |
| 14 | 1359.20 | 523.03 | 1469.89 | 538.64 | 3011.15 | 515.41 | 3614.09 | 530.56 |
| 15 | 1359.20 | 517.79 | 1469.89 | 533.09 | 3011.15 | 512.07 | 3614.09 | 527.02 |
| 16 | 1359.20 | 513.88 | 1469.89 | 528.94 | 3011.15 | 509.47 | 3614.09 | 524.27 |
| 17 | 1359.20 | 510.89 | 1469.89 | 525.77 | 3011.15 | 507.41 | 3614.09 | 522.08 |
| 18 | 1359.20 | 508.54 | 1469.89 | 523.28 | 3011.15 | 505.74 | 3614.09 | 520.32 |
| 19 | 1359.20 | 506.66 | 1469.89 | 521.29 | 3011.15 | 504.38 | 3614.09 | 518.88 |
| 20 | 1359.20 | 505.13 | 1469.89 | 519.68 | 3011.15 | 503.25 | 3614.09 | 517.68 |
| n → ∞ | 1359.20 | 494 | 1469.89 | 508 | 3011.15 | 494 | 3614.09 | 508 |

It should be appreciated that the specific examples of laser wavelength pairs and input laser wavelength pairs provided herein are not the only wavelengths that may be used or generated, as aspects of the technology described herein are not limited in this respect. For example, in some embodiments, the laser wavelength pairs and/or the entangled photon wavelength pairs may be in a range from 700 nm to 925 nm and in a range from 1300 nm to 1600 nm. Any suitable wavelengths corresponding to the atomic species' desired atomic transition energies may be selected from within these ranges.

For the photon source to exhibit the desired values of brightness, large one- and two-photon detunings of the first and second laser beams 102, 104 are implemented. A lower bound on the two-photon detuning is determined by the velocity of atoms inside the atomic vapor cell 114 at different temperatures. The atomic velocity is resonantly excited at:

$$v \approx - \frac{c δ}{ω}$$

where c is the speed of light, δ is the two-photon detuning, and w is the energy of the double excited state (e.g., the |6S_{1/2} [symbol] state in the example of FIG. 2). This velocity is ideally much larger than the characteristic atomic velocity, vₚ:

$${v}_{p} = \sqrt{\frac{2 {k}_{B} T}{m}}$$

where m is the atomic mass of the atoms of the atomic vapor. Or, alternatively, it is desirable for δ to have a value of:

$$δ ≫ \frac{ω}{c} \sqrt{\frac{2 {k}_{B}}{m}}$$

For the example of FIG. 2, δ>>2π×2 GHz, as described below. While the technique has been presented for the specific diamond, two-photon scheme shown FIG. 2, it should be appreciated that it is generally applicable to atomic species exhibiting diamond, two-photon excitations.

In some embodiments, the first and second laser beams 102, 104 may be configured with large detunings relative to atomic transitions of the atomic species in the atomic vapor. In some embodiments, the detuning of the first laser beam 102 may be greater than the resonant Doppler broadening of the atomic species. For example, the detuning of the first laser beam 102 may be approximately equal to or greater than 2π×1 GHz, 2π×1.1 GHz, or 2π×1.15 GHz and may be less than or equal to 2π×10 GHz. As shown in the example of FIG. 2, the first laser beam 102 may be frequency stabilized to the ⁸⁵Rb transition between a first energy level 202, at the |5S_{1/2}, F=3 [symbol] state, to a second energy level 204, at the |5P_{3/2}, F′=4 [symbol] state such that the detuning amount, Δ, is approximately 2π×1.1 GHz. That is, the first laser beam 102 may be blue detuned from the ⁸⁵Rb |5S_{1/2}, F=2 [symbol] →|5P_{3/2}, F′=3) [symbol] transition.

In some embodiments, the second laser beam 104 may be configured with a detuning relative to an atomic transition between the second energy level 204 and a third energy level 206 (e.g., the |6S_{1/2} [symbol] state) and the first detuning, A. The detuning of the second laser beam 104 may be controlled, for example, using an electro-optic modulator (EOM; not shown). In some embodiments, the detuning of the second laser beam 104 may be greater than the double-resonant Doppler broadening of the atomic species. For example, the detuning of the second laser beam 104 may be approximately equal to or greater than 2π×2 GHz or 2π×2.4 GHz and less than or equal to 2π×10 GHz.

By configuring the first laser beam 102 and the second laser beam 104 with detunings relative to atomic transitions of the atomic species in the atomic vapor cell 114, the corresponding two-photon resonance may be used to generate entangled photon pairs upon decay of the excited atomic state. As shown in the example of FIG. 2, the decay of the excited atomic state may occur through the |5P_{1/2} [symbol] state 208, in some embodiments, yielding entangled pairs of photons having signal photons with wavelengths of approximately 1324 nm and idler photons with wavelengths of approximately 795 nm.

Returning to FIG. 1, the generated entangled photon pairs may be coupled out of the atomic vapor cell 114 by another lens 116 mirroring the lens 112 (e.g., the lens 116 may also be an achromatic lens with f≈50 mm). Both photons of the generated photon pairs may be coupled into collimators (not depicted) with equivalent 1/e² mode radii of approximately 20 μm. Thereafter, in some embodiments, the generated photon pairs and first and second laser beams 102, 104 may pass through a dichroic mirror 118 configured to separate the two photons of the generated photon pairs (e.g., based on wavelength).

In some embodiments, a first photon of the generated photon pairs may be deflected by the dichroic mirror 118 towards output 122. The first photon may be, for example, the photon of the photon pairs having a wavelength compatible with telecom applications (e.g., in a range from 1300-1600 nm). Prior to exiting the photon source 100, the first photon may further pass through a bandpass filter 120a configured to filter out photons from the first and second laser beams 102, 104 such that only first photons reach the output 122.

In some embodiments, the second photon of the generated photon pairs may pass through the dichroic mirror 118 and through a liquid crystal retardation plate 124 prior to being steered towards output 128 by mirror 126. The second photon may be, for example, the photon of the photon pairs having a near-infrared wavelength (e.g., in a range from 700-925 nm). The liquid crystal retardation plate 124 may be aligned so that the slow axis of the liquid crystal retardation plate 124 is in a vertical direction (e.g., out of the page of FIG. 1). By tuning the retardance of the liquid crystal retardation plate 124, arbitrary phase shifts between the |H [symbol] and |V [symbol] polarization modes may be applied to the second photon. In some embodiments, a bandpass filter 120b may also be optically coupled between the liquid crystal retardation plate 124 and the output 128. The bandpass filter 120b may be configured to filter out photons from the first and second laser beams 102, 104 such that only the second photons reach the output 128.

In some embodiments, additional optical components may be disposed between the dichroic mirror 118 and the output 122 or between the liquid crystal retardation plate 124 and the output 128 that are not depicted in the example of FIG. 1. For example, one or more of a quarter waveplate, half waveplate, and/or polarizing beamsplitter may be optically coupled along the beam path between the dichroic mirror 118 and the output 122 or along the beam path between the liquid crystal retardation plate 124 and the output 128. These additional optical components, for example, may be used to select generated photons of detected polarization modes.

It should be appreciated that while the example of FIG. 1 depicts a photon source 100 that is not multiplexed, that multiplexing of the photon source 100 may be achieved by splitting the first laser beam 102 and the second laser beam 104 into multiple paths (e.g., on a two-dimensional or three-dimensional grid), as aspects of the technology are not limited in this respect. This splitting may be achieved, for example, to simultaneously excite many microscopic-sized atomic vapor cells or in hollow core fibers. The multiplexed photon outputs may then be collected into different optical fiber outputs.

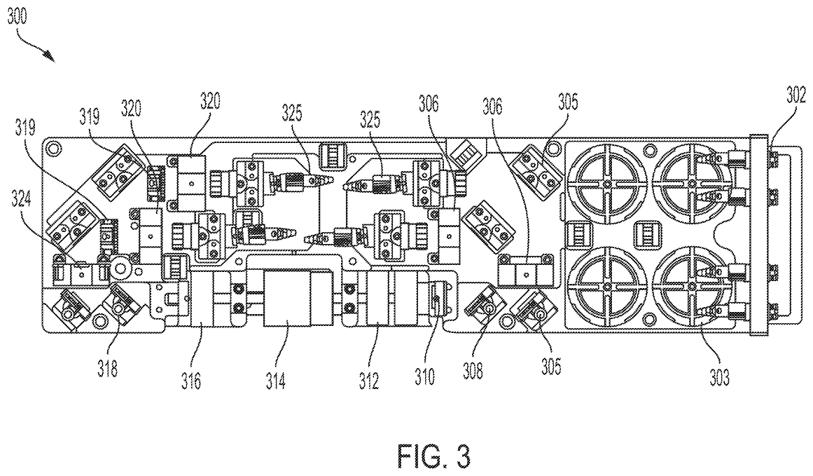

The inventors have further recognized and appreciated that miniaturization of a photon source (e.g., photon source 100) would be advantageous for improved mass-production, a reduced form-factor, and compatibility and ease of integration with existing telecommunications infrastructure. As an example, FIG. 3 shows an illustrative diagram of photon source 300 arranged in a rack-mounted housing, in accordance with some embodiments described herein. The rack-mounted housing of FIG. 3 may have a footprint size equal to or less than 6 inches×15 inches×2 inches, ensuring the module can be used in a variety of locations and experiments as well as integrated into a deployable rackmount unit.

In some embodiments, the photon source 300 may include inputs 302 that may be optically coupled to first and second lasers, which may be external to the photon source 300. For example, the first and second lasers may be disposed in another portion of the rackmount unit and may be optically coupled to the photon source 300 by optical fibers. Alternatively, the first and second lasers may be a part of photon source 300 and may be disposed within the rack-mounted housing.

In some embodiments, the photon source 300 may receive first and second laser beams from the first and second lasers. The first and second laser beams may pass through optical fiber spools 303 and coupled into free space optics by fiber collimators 325. The first and second laser beams may be output from fiber collimators 325 to bandpass filters 306 (e.g., equivalent to bandpass filters 106a and 106b as described in connection with FIG. 1).

In some embodiments, the first and second laser beams may be steered towards dichroic mirror 308 by one or more mirrors 305. The first and second laser beams may also be arranged to co-propagate along a same beam path by one or more mirrors 305 and/or the dichroic mirror 308. After passing through dichroic mirror 308, the first and second laser beams may pass through polarizer 310 prior to entering the telescope formed by lenses 312 and 316, with atomic vapor cell 314 disposed at the center of the telescope optics. The lens 312 may be configured to reduce a beam diameter (e.g., as described in connection with lens 112 in the example of FIG. 1) of the first and second laser beams before they enter the atomic vapor cell 314.

In some embodiments, the first and second laser beams may cause a four-wave mixing process to occur within the atomic vapor cell 314, as described above. The four-wave mixing process may cause entangled photon pairs to exit the atomic vapor cell 314 along with photons of the first and second laser beams. The photons exiting from the atomic vapor cell 314 may thereafter pass through the lens 316, which may be configured to symmetrically expand the beam diameter.

In some embodiments, the photons exiting from the atomic vapor cell 314 may first pass through a dichroic mirror 318 configured to split the photons of the entangled photon pairs having different wavelengths. First photons of the entangled photon pairs may next pass through a half wave plate 319 and a bandpass filter 320 configured to filter out any remaining photons from the first and/or second laser beams. Second photons of the entangled photon pairs may be steered (e.g., by another mirror) to pass through a liquid crystal retardation plate 324 prior to passing through a separate half-wave plate 319 and bandpass filter 320. After exiting the bandpass filters 320, the first and second photons may be coupled back into optical fibers by fiber collimators 325. The first and second photons may then pass through separate fiber spools 303, exiting the photon source 300 through optical fiber outputs.

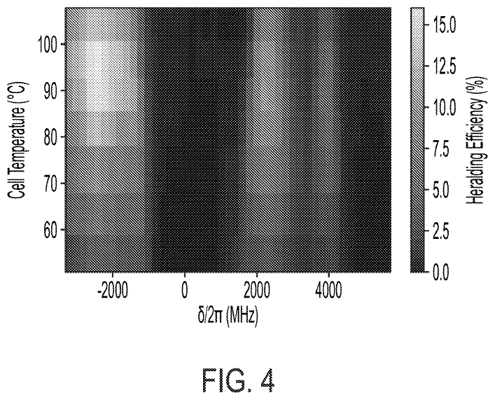

The inventors have recognized and appreciated that the detunings of the pump laser beams have a significant effect on operational parameters of photon sources (e.g., photon source 100 and/or 300, as described herein). The heralding efficiency for a photon source as described herein is a probability of detecting one photon of a generated photon pair upon the detection of another photon of the generated photon pair. FIG. 4 is a heatmap of heralding efficiency as a function of vapor cell temperature and two-photon detuning, in accordance with some embodiments of the technology described herein. In the case of FIG. 4, the heralding efficiency is the probability of detecting a 795-nm photon upon the detection of a 1324-nm photon.

To collect the data of FIG. 4, the pump power was fixed at approximately 250 μW, and the coupling power was varied to maintain a detected signal rate of approximately 100 kcps. The two-photon detuning, δ, was varied using an EOM in an offset dual resonance optical pumping (DROP) lock. Varying the vapor cell temperature varies the optical depth of the atomic vapor in the vapor cell. Only the |VV) mode of the source was measured. In FIG. 4, it is shown that for a fixed atomic temperature, the heralding efficiency may be increased by increasing the two-photon detuning.

This behavior may be understood by analyzing the three-level Hamiltonian associated with the excitation process, under the rotating wave approximation, for a rubidium atom with velocity, v, in the {|5S_{1/2} [symbol] , |5P_{3/2} [symbol] , |6S_{1/2} [symbol] } basis:

$$H ( v ) = ℏ ( \begin{matrix}0 & \frac{{Ω}_{p}}{2} & 0 \\ \frac{{Ω}_{p}^{*}}{2} & - Δ ( v ) & \frac{{Ω}_{c}}{2} \\ 0 & \frac{{Ω}_{c}^{*}}{2} & - δ ( v )\end{matrix} )$$

where Ωₚ and Ω_{c} are the pump and coupling Rabi frequencies, respectively. The |6S_{1/2} [symbol] →|5P_{1/2} [symbol] →|5S_{1/2} [symbol] transitions may be treated as an effective |6S_{1/2} [symbol] =>|5S_{1/2} [symbol] decay, in addition to the |6S_{1/2} [symbol] ′|5P_{3/2} [symbol] and |5P_{3/2} [symbol] →|5S_{1/2} [symbol] decay channels.

The atomic motion may be treated as one-dimensional along the propagation of the pump and coupling laser beams. The large single photon detuning avoids significantly populating the |5P_{3/2} [symbol] state. The steady state of the Liouvillian associated with the reduced three-level system may then be numerically solved. As the |6S_{1/2} [symbol] →|5P_{1/2} [symbol] decay rate is proportional to the |6S_{1/2} [symbol] steady state population, this decay rate may be used as a proxy for the signal photon scattering probability.

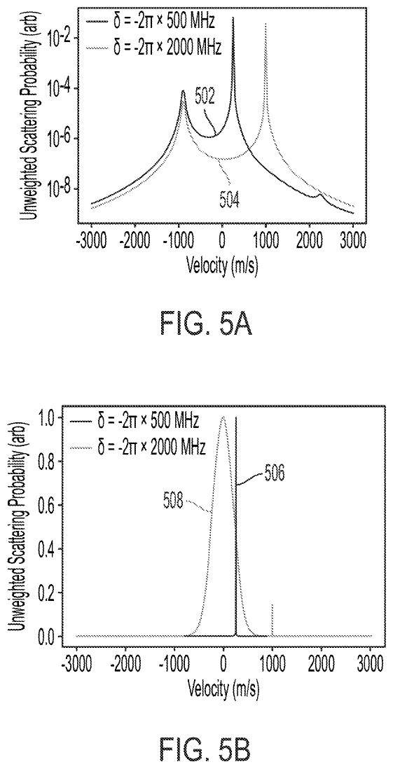

FIG. 5A shows two examples of numerically simulated, unweighted scattering probabilities as a function atomic velocity, in accordance with some embodiments of the technology described herein. Curve 502 is the unweighted scattering probability for a small detuning of 2π×500 MHz, and curve 504 is the unweighted scattering probability for a large detuning of 2π×2000 MHz. Both curve 502 and curve 504 show sharp resonant peaks for v≈250 m/s and v≈1000 m/s, which is seen in the scattering probability at

$$v \approx - \frac{c δ}{{ω}_{\vert 6 {S}_{1 / 2} 〉}}$$

due to the two-photon Doppler shift, where [symbol] is the energy of the |6S_{1/2} [symbol] state. Two broader and less prominent peaks are seen in curves 502 and 504 at v≈−1000 m/s, where the |5P_{3/2} [symbol] state is resonantly excited.

To determine the scattering probability in the atomic vapor, the |6S_{1/2} [symbol] is weighted by the Maxwell-Boltzmann distribution, as shown in FIG. 5B. Curve 506 is the weighted scattering probability for the small detuning of 2π×500 MHz, and curve 508 is the weighted scattering probability for the large detuning of 2π×2000 MHz. For the small detuning case, a significant fraction of the population resides at the resonant velocity class, giving rise to a sharp feature in the figure. However, for the large detuning case, the resonant velocity has a near negligible population fraction, and the majority of the scattering occurs off-resonance despite the unweighted scattering probability for this process is significantly smaller than for resonant scattering. Additionally, as seen in FIG. 5B, curve 508 follows the Maxwell-Boltzmann distribution. For simulations in both FIGS. 5A and 5B, the pump detuning was fixed far from resonance (Δ/2π=1150 MHz), the pump and coupling Rabi frequencies were held at reasonable experimental values (Ωₚ/2π=Ω_{c}/2π=350 MHz), and temperature was fixed at T=80° C.

The behavior illustrated by FIGS. 5A and 5B can be understood by considering the collective excitation projected onto the atomic system upon detection of a signal photon. The likelihood of phase matched emission of the idler scales with the atom number participating in the collective excitation. Given that the collective excitation has a distribution similar to that of the weighted scattering probability, it is expected, for a fixed atomic density, that phase-matched emission of the idler would be more likely for off-resonant excitation relative to near-resonant excitation. For a given vapor temperature, higher heralding efficiencies are therefore expected when the source is operated in the far-off-resonant regime as seen in FIG. 4.

From the above theoretical model, it would be expected that the source behavior would be symmetric about zero two-photon detuning. However, FIG. 4 shows that this is not the case. This unexpected behavior can be attributed to undesired interactions between the pump lasers and ⁸⁵Rb impurities within the ≈99% ⁸⁷Rb purity atomic vapor at positive two-photon detunings. Additionally, it would be expected that the heralding efficiency would saturate to a constant value at large two-photon detunings. However, FIG. 4 shows a clear peak in the heralding efficiency as the two-photon detuning is increased, which may be related to the increased coupling power used to implement large two-photon detunings.

In addition to the above-described trends in the heralding efficiency as the two-photon detuning is changed, as shown in FIG. 4, for fixed two-photon detuning, a peak in the heralding efficiency is observed as the vapor cell temperature is altered. This phenomenon is attributed to the competing processes of an increase in directed collective emission, and decrease in idler photon transmission, as the vapor temperature, and therefore optical depth (OD), is increased.

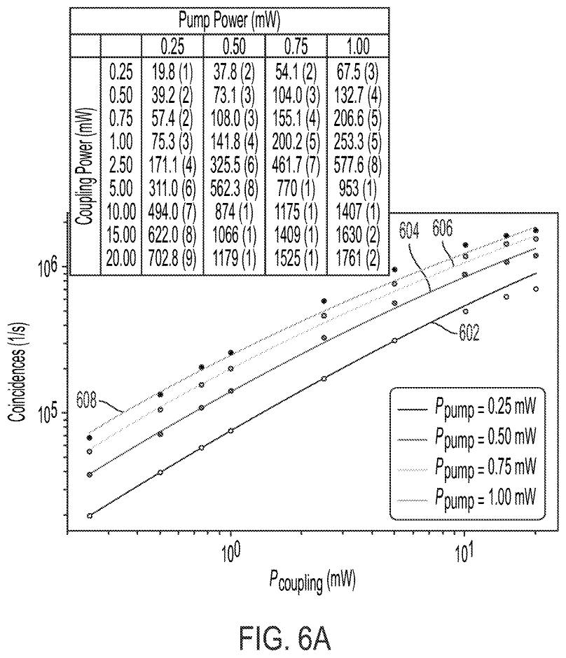

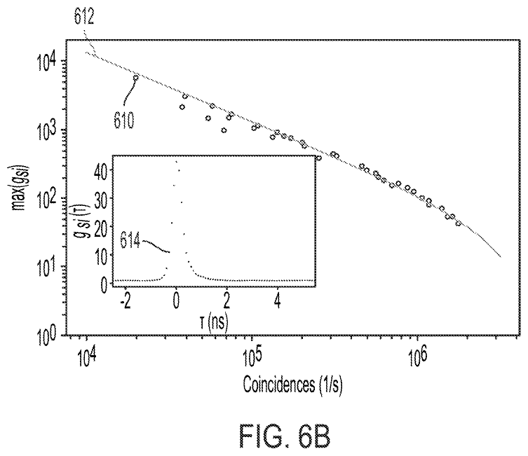

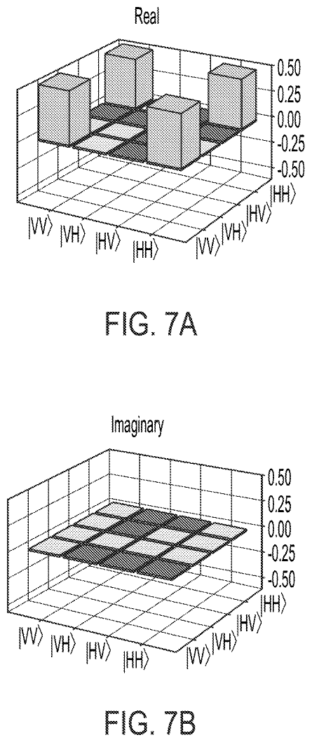

Next, scaling properties of the source with the coupling and pump powers are investigated. For the measurements used to generate FIGS. 6A-7B, the photon source was operated with a two-photon detuning of δ/2π≈−2400 MHz and an atomic vapor cell temperature of approximately 93° C., as measured spectroscopically, where the maximum measured heralding efficiency is approximately 16% (or approximately 24% when corrected for idler detection efficiency). This value of maximum heralding efficiency is comparable to the detector-corrected heralding efficiency observed for nearly-Doppler-free ladder pair sources. The resonant OD of the atomic vapor cell for the idler photons is approximately 9. Measurements were acquired for only the |VV) mode of the photon source.

FIG. 6A shows measured signal-idler coincidence rates as a function of coupling power for various pump powers, in accordance with some embodiments of the technology described herein. FIG. 6A includes curves 602, 604, 606, and 608, which are fitted curves to measured coincidences as a function of coupling power for pump powers of 0.25 mW, 0.50 mW, 0.75 mW, and 1.00 mW, respectively. For low pump and coupling power, FIG. 6A shows a near-linear scaling in the coincidence rate as function of power, with a measured scaling constant of approximately 3×10⁵/s/mW², or approximately 6×10⁵/s/mW² when accounting for detection efficiencies. At high power, a saturation in the coincidence rate is observed for increasing power. This saturation is partly due to the finite dead time of the detectors, which is approximately 20 ns for both the signal and idler detectors. This dead time is accounted for in the fitting used to generate curves 602-608. However, even upon repeating these measurements using neutral density filters on both of the signal idler paths, the deviation from linearity at higher coupling powers is still observed. This is attributed to saturation of the atomic medium.

Similar to other sources, as the pair production rate is increased, the signal-idler cross-correlation function, gₛᵢ, is expected to decrease. The scaling of the maximum value of gₛᵢ with measured coincidence values is shown in FIG. 6B, which includes data points 610 and a fitting curve 612. Additionally, a typical gₛᵢ values 614 are shown as an inset, the values 614 being plotted as a function of the delay time between detections, t. In theory, gₛᵢ∝1/coincidences, and this inverse scaling is observed for low coincidence rates. However, for high coincidence rates the behavior of gₛᵢ deviates from the expected inverse scaling. This deviation is attributed to the finite detector dead time, as this deviation is not seen when the measurement is repeated using neutral density filters on the signal and idler arms. The detector saturation is taken into account in the fitting used to generate curve 612.

At the maximum powers of 1 and 20 mW, for the pump and coupling beams respectively, the measured |VV [symbol] coincidence rate is approximately 1.7×10⁶ s⁻¹ with gₛᵢ≈40. This coincidence rate corresponds to a |VV [symbol] mode rate of approximately 5×10⁶ s⁻¹ when detection efficiency and dead time saturation of the detectors are corrected for.

From the gₛᵢ values 614, the biphoton linewidth is estimated to be less than 2π×1 GHz after deconvolving the finite response time of the detectors. The estimated biphoton linewidth is similar to that observed in ladder-type four-wave mixing systems where all velocity classes of atoms in the atomic vapor participate in the collective excitation. The biphoton bandwidth is attributed to the convolution of the Doppler-broadened emission and the absorption of the idler as it propagates through the atomic vapor cell. Similar variability of the bandwidth with OD is expected. This observed bandwidth is comparable to bandwidths demonstrated by warm atom quantum memories, making the photon sources described herein suitable for all warm-atom-based telecom-compatible quantum repeaters.

With the pumping scheme described herein, and the rubidium Zeeman structure, the photon source is expected to produce

$$\vert {Φ}_{+} 〉 = \frac{1}{\sqrt{2}} ( \vert HH 〉 + \vert VV 〉 )$$

entangled pairs. The dichroic mirror (e.g., dichroic mirror 118 and/or 318, as described herein) used to separate the signal and idler photons and mirrors used to couple the signal and idler photons into their respective optical fibers add an arbitrary but stable phase shift between the |HH [symbol] and |VV [symbol] modes. The retardance of the liquid crystal retardation plate (e.g., liquid crystal retardation plate 124 and/or liquid crystal retardation plate 324 as described herein) can be tuned to compensate for these phase shifts, recovering the |φ₊ [symbol] state.

To verify the entangled state produced after this operation, two-photon tomography is performed. Neutral density filters with an OD of approximately one are used on both the signal and idler paths to ensure that detector saturation does not affect the tomography. Using the maximum likelihood method, the density matrix for the two-photon state is reconstructed and shown in FIGS. 7A and 7B. FIG. 7A shows the real portions of the density matrix, and FIG. 7B shows the imaginary portions of the density matrix. From the reconstructed density matrix, a lower bound is placed on fidelity to the |φ₊ [symbol] Bell state of 95%, for an entangled pair rate greater than 107 s⁻¹

### II. Heralded Single Photon Source

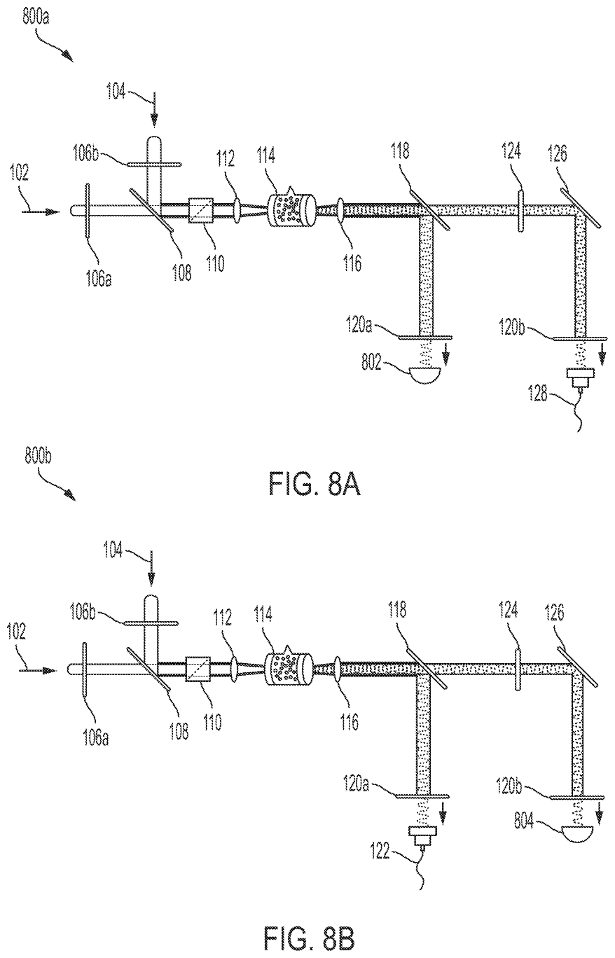

The inventors have further recognized and appreciated that the photon sources described herein (e.g., photon sources 100 and/or 300) may be converted into a heralded single photon source by placing a single photon detector on one of the two outputs (e.g., outputs 122 or 128, as described in connection with FIG. 1). FIGS. 8A and 8B are schematic diagrams of heralded single photon sources 800a and 800b, respectively, in accordance with some embodiments described herein. The heralded single photon sources 800a and 800b are similar to the photon source 100 and are operated with the same large detunings as described in connection with FIG. 1. However, the heralded single photon sources 800a and 800b include single photon detectors 802 or 804 in the place of outputs 122 or 128, respectively. For example, the heralded single photon source 800a of FIG. 8A includes a single photon detector 802 in the place of output 122, such that the heralded single photon source 800a acts as a heralded single photon source at NIR wavelengths (e.g., in a range from 700 nm to 925 nm, or at approximately 780 or 795 nm, in some embodiments). Alternatively, the heralded single photon source 800b of FIG. 8B includes a single photon detector 804 in the place of output 128, such that the heralded single photon source 800b acts as a heralded single photon source at telecom wavelengths (e.g., in a range from 1300 nm to 1600 nm, or at approximately 1324 nm, 1367 nm, 1479 nm, or 1529 nm, in some embodiments). It should be appreciated that the heralded single photon sources 800a and 800b could be, in some embodiments, configured to generate a single heralded photon at any of the possible wavelengths in connection with alkali atomic species.

A probabilistic heralded source has a heralded g⁽²⁾ that scales roughly like:

$${g}_{heralded}^{( 2 )} ( 0 ) \approx 2 ( 2 - η ) 〈 n 〉$$

where g⁽²⁾ is the degree of second-order coherence, n is the detection efficiency of the heralded photon, and n is the number of counts as a function of time, t. To be classified as a single photon, g⁽²⁾ must be less than 0.5 such that:

$$〈 n 〉 \leq 0.25 ,$$

which is equivalent to a rate of around 200 MHz for a bandwidth of approximately 1 GHz. Thus, when acting as a heralded single photon source, the photon sources described herein can generate as many as 2×10⁸ single photons per second.

The inventors have recognized that the heralding efficiency of a heralded single photon source as described herein may be improved with the addition of filtering prior to outputting of the single photon. Due to absorption on the lower atomic transition, there are single photons from the upper atomic transition that are unpaired with photons generated by the lower atomic transition. Placing a filter prior to the output for the photons derived from the upper atomic transition can accordingly increase the heralding efficiency of the heralded single photon source.

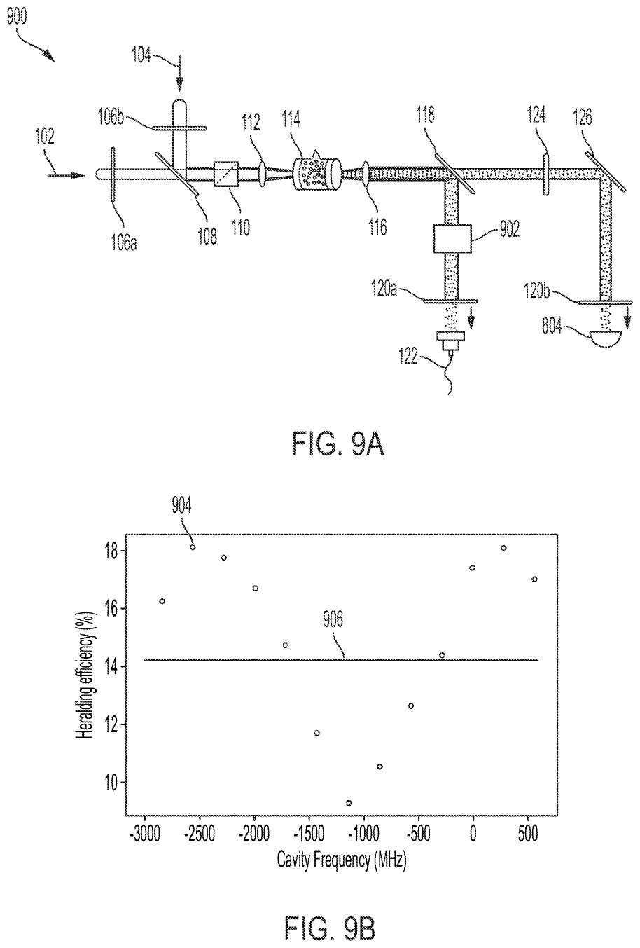

FIG. 9A is a schematic diagram of an example of a filtered, heralded single photon source 900, in accordance with some embodiments of the technology described herein. The filtered, heralded single photon source 900 is similar to the heralded single photon source 800b of FIG. 8B, but further includes a filter 902 disposed along the optical path between the dichroic mirror 118 and the output 122. The filter 902 may be, for example, an etalon (e.g., a Fabry-Perót etalon).

FIG. 9B is a plot showing the measured heralding efficiency values 904 of the photons on the lower atomic transition of the atomic species (e.g., the idler photons) as a function of the frequency of a filter (e.g., filter 902 of FIG. 9A) placed on the photons on the upper atomic transition of the atomic species (e.g., the signal photons). Line 906 shows the heralding efficiency when no filter is present. As seen in FIG. 9B, the heralding efficiency can be increased by filtering out unpaired single photons from the single photon output.

The inventors have further recognized that the photon source, when acting as a heralded single photon source, may be implemented using multiplexing to make the heralded single photon source act as a plurality of separate photon sources. The multiplexing may be implemented in one or more ways. A simple multiplexing scheme is based on the native polarization-based entanglement of the entangled photon pairs. That is, heralding may be performed separately for the |H [symbol] [symbol] - and |V [symbol] -polarized photon pairs to provide two multiplexed channels.

Alternatively or additionally, temporal multiplexing may be implemented in some embodiments. To implement temporal multiplexing, the photon source may be pumped repeatedly, and the photons generated from the upper atomic transition (e.g., the telecom photons) may be delayed. For example, the photons generated from the upper atomic transition may be delayed using extra lengths of optical fiber. While the telecom photons are delayed, a heralding click in a given temporal mode on the herald is used to indicate that an NIR photon has been detected, and an optical switch may be used to select and transmit the appropriate telecom photon.

Alternatively or additionally, spatial multiplexing may be implemented in some embodiments. Spatial multiplexing may be implemented using a plurality of photon sources (e.g., within a same atomic vapor cell or within multiple atomic vapor cell) to simultaneously produce entangled photon pairs. A telecom photon may then be transmitted out of the photon source from a spatial mode associated with a received heralding click.

In some embodiments, multiple multiplexing techniques may be combined. For example, 10 multiplexing channels may be achieved using polarization multiplexing and five temporal modes. As another example, temporal, frequency, polarization, and spatial multiplexing techniques may be implemented simultaneously to multiplex in a four-dimensional state space, resulting in greater than 1000 multiplexed states being generated using a same photon source.

In some embodiments, temporal, frequency, polarization, and spatial multiplexing techniques may be implemented simultaneously to generate multiple photon pairs from a same atom, creating a deterministic heralded single photon source for applications in quantum computing and secure communications.

Alternatively or additionally, to reduce multiplexing, photon number resolving detectors may be used in place of single photon detectors in the heralded single photon sources (e.g., heralded single photon sources 800a, 800b, and/or 900). The photon number resolving detectors may reduce the number of multiplexing states required for an application by permitting the passage of p1 events and the filtering out of p2 events.

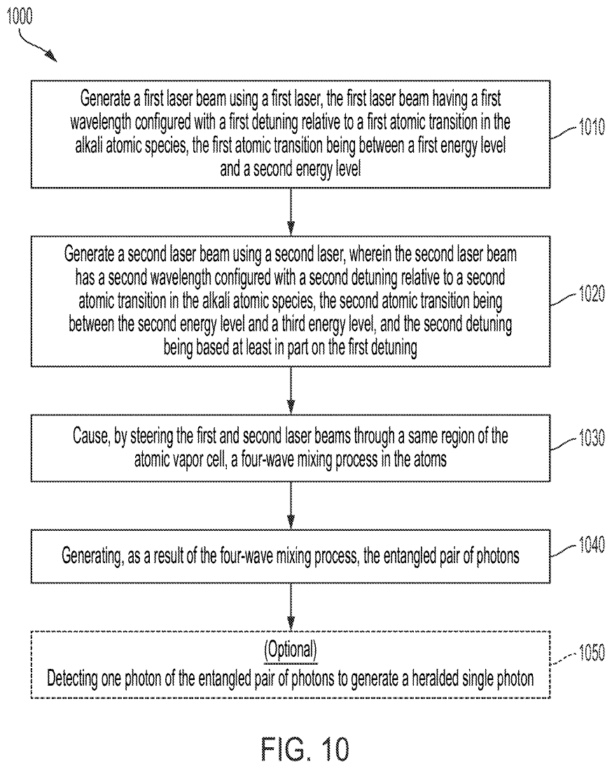

FIG. 10 is a flowchart describing a process 1000 of generated an entangled pair of photons, in accordance with some embodiments of the technology described herein. The process 1000 may be performed using any one of photon sources 100 and/or 300, and/or optionally any one of heralded single photon sources 800a, 800b, or 900 described herein. The process 1000 may begin at act 1010, wherein a first laser beam is generated using a first laser. The first laser beam has a first wavelength (e.g., 780 nm or 795 nm, in some embodiments).

In some embodiments, the first laser beam is configured with a first detuning relative to a first atomic transition of an alkali atomic species contained within an atomic vapor cell. The alkali atomic species may be, for example ⁸⁷Rb, ¹³³Cs, or any suitable alkali atomic isotope. The first atomic transition may be between a first energy level of the atomic species and a second energy level of the atomic species, the second energy level being higher than the first energy level. As one non-limiting example, the first atomic transition may be between a |5P_{1/2} [symbol] state and a |5P_{3/2} [symbol] state of ⁸⁷Rb, in some embodiments.

In some embodiments, the first detuning relative to the first atomic transition may be a one-photon detuning, A, as described herein. The first laser beam may be generated with a first detuning that is greater than a one-photon resonant Doppler broadening of the alkali atomic species and less than or equal to 2π×10 GHz. As some non-limiting examples, the first detuning may be approximately 2π×1 GHz, approximately 2π×1.1 GHz, or approximately 2π×1.15 GHz, in some embodiments.

In some embodiments, after act 1010, the process 1000 may proceed to act 1020, where a second laser beam is generated using a second laser. The second laser beam has a second wavelength (e.g., 1324 nm or 1367 nm, in some embodiments). The second laser beam may be configured with a second detuning relative to a second atomic transition of the alkali atomic species contained within the atomic vapor cell and relative to the first detuning. In some embodiments, the second atomic transition is between the second energy level of the alkali atomic species and a third energy level of the alkali atomic species. As one non-limiting example, the second atomic transition may be between the |5P^{3/2} [symbol] state and the |6S_{1/2} [symbol] state of ⁸⁷Rb.

In some embodiments, the second detuning may be a two-photon detuning. The second detuning may also be larger than a double-resonant Doppler broadening of the alkali atomic species and less than or equal to 2π×10 GHz. As some non-limiting examples, the second detuning may be approximately 2π×2 GHz or approximately 2π×2.4 GHz.

In some embodiments, generating the first laser beam in act 1010 and/or generating the second laser beam in act 1020 may comprise generating the first laser beam and/or the second laser beam with a power of approximately 5 mW. Alternatively or additionally, generating the first laser beam in act 1010 and/or generating the second laser beam in act 1020 may comprise generating the first laser beam and/or the second laser beam with a beam diameter of approximately 20-50 μm (e.g., the beam diameter being reduced within a volume of the atomic vapor cell, in some embodiments).

In some embodiments, after act 1020, the process 1000 may procced to act 1030, wherein a four-wave mixing process is caused in the atoms of the atomic vapor cell by steering the first and second laser beams through a same region of the atomic vapor cell. The first and second laser beams may be steered, for example, by one or more mirrors, dichroic mirrors, bandpass filters, and/or lenses. In some embodiments, steering the first and second laser beams through the same region of the atomic vapor cell comprises causing the first and second laser beams to be co-propagating through the atomic vapor cell (e.g., such that the first and second laser beams overlap in a same volume within the atomic vapor cell).

In some embodiments, after act 1030, the process 1000 may proceed to act 1040, where the entangled pair of photons may be generated as a result of the four-wave mixing process. The entangled pair of photons may be a bichromatic entangled pair of photons such that the photon pair comprises a first photon having a first wavelength and a second photon having as second wavelength. For example, the first photon may have a wavelength compatible with telecommunications technology (e.g., being in a range from 1300 nm to 1600 nm, being approximately 1324 nm, 1367 nm, 1479 nm, and/or 1529 nm). The second photon may have a wavelength that is an NIR wavelength (e.g., in a range from 700 nm to 925 nm, or being approximately 795 nm or approximately 780 nm).

In some embodiments, after act 1040, the process 1000 may optionally proceed to act 1050, where one photon of the entangled pair of photons is detected to generate a heralded single photon (e.g., as described in connection with the heralded single photon sources 800a, 800b, and/or 900 described herein). The detected photon may be detected, for example, using a single photon detector, in some embodiments. In some embodiments, the other photon of the entangled pair of photons (e.g., the photon that is not detected) may be filtered using, for example an etalon (e.g., a Fabry-Perót etalon) prior to being output from the heralded single photon source.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The use of “coupled” or “connected” is meant to refer to elements, or signals, that are either directly linked to one another or are linked through intermediate components. Elements that are not “coupled” or “connected” are “decoupled” or “disconnected.”

The use of “between” in a coupled signal chain is not meant to require a particular direction of signal flow in the signal chain unless stated otherwise. For instance, where element B is described as coupled between elements A and C in a signal chain, signals may flow from element A to element C through element B and/or from element C to element A through element B unless stated otherwise.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A photon source, comprising:
an atomic vapor cell comprising atoms of an alkali atomic species, the atomic vapor cell being disposed in beam paths of a first laser beam and a second laser beam generated during operation of the photon source, wherein:
the alkali atomic species comprises a first energy level, a second energy level, and a third energy level, wherein the second energy level is at a higher energy than the first energy level, and the third energy level is at a higher energy than the second energy level, and, during operation of the photon source:
the first laser beam has a first wavelength configured with a first detuning relative to a first atomic transition in the alkali atomic species, the first atomic transition being between the first energy level and the second energy level, and
the second laser beam has a second wavelength configured with a second detuning relative to a second atomic transition in the alkali atomic species, the second atomic transition being between the second and third energy levels, and the second detuning being based at least in part on the first detuning.

2. The photon source of claim 1, wherein, during operation of the photon source, the first laser beam is arranged to be co-propagating with the second laser beam through the atomic vapor cell.

3. The photon source of claim 1 or 2, wherein the first wavelength and the second wavelength have values configured to satisfy conditions for a four-wave mixing process in the alkali atomic species.

4. The photon source of any one of claims 1-3, wherein the first detuning is greater than a one-photon resonant Doppler broadening of the alkali atomic species and less than or equal to 2π×10 GHz.

5. The photon source of any one of claims 1-3, wherein the first detuning is approximately 2π×1 GHz.

6. The photon source of any one of claims 1-3, wherein the first detuning is approximately 2π×1.1 GHz.

7. The photon source of any one of claims 1-3, wherein the first detuning is approximately 2π×1.15 GHz.

8. The photon source of any one of claims 1-7, wherein the first energy level is a |5S_{1/2} [symbol] state, the second energy level is a |5P_{3/2} [symbol] state, and the third energy level is a |6S_{1/2} [symbol] state.

9. The photon source of any one of claims 1-8, wherein the first wavelength is approximately 780 nm.

10. The photon source of any one of claims 1-9, wherein the second detuning is a two-photon detuning that is larger than a double-resonant Doppler broadening of the alkali atomic species and less than or equal to 2π×10 GHz.

11. The photon source of any one of claims 1-10, wherein the second detuning is approximately 2π×2 GHz.

12. The photon source of any one of claims 1-10, wherein the second detuning is approximately 2π×2.4 GHz.

13. The photon source of any one of claims 1-12, wherein the second wavelength is approximately 1367 nm.

14. The photon source of any one of claims 1-13, wherein the first laser beam and/or the second laser beam are operated with a power of approximately 5 mW.

15. The photon source of any one of claims 1-14, wherein the first laser beam and/or the second laser beam are operated with a beam diameter of approximately 50 μm.

16. The photon source of any one of claims 1-15, wherein, during operation of the photon source, the atomic vapor cell is configured to output bichromatic entangled pairs of photons.

17. The photon source of claim 16, wherein the bichromatic entangled pairs of photons each comprise a first photon and a second photon, wherein the first photon and the second photon have different wavelengths.

18. The photon source of claim 17, wherein the first photon has a wavelength compatible with telecommunications technology.

19. The photon source of claim 17 or 18, wherein the first photon has a wavelength in a range from 1300 nm to 1600 nm.

20. The photon source of any one of claims 17-19, wherein the first photon has a wavelength that is approximately 1324 nm.

21. The photon source of any one of claims 17-20, wherein the first photon has a wavelength that is approximately 1324 nm, 1367 nm, 1476 nm, or 1529 nm.

22. The photon source of any one of claims 17-21, wherein the second photon has a near-infrared (NIR) wavelength.

23. The photon source of any one of claims 17-22, wherein the second photon has a wavelength in a range from 700 nm to 925 nm.

24. The photon source of any one of claims 17-23, wherein the second photon has a wavelength of approximately 795 nm.

25. The photon source of any one of claims 17-23, wherein the second photon has a wavelength of approximately 795 nm or 780 nm.

26. The photon source of any one of claims 17-25, further comprising a first output and a second output, each optically coupled to outputs of the atomic vapor cell such that the first photon exits the photon source from the first output and the second photon exits the photon source from the second output.

27. The photon source of claim 26, further comprising a single photon detector optically coupled to either the first output or the second output.

28. The photon source of claim 26, further comprising:
a Fabry-Perót etalon optically coupled between an output of the atomic vapor cell and the first output; and
a single photon detector optically coupled to the second output.

29. The photon source of any one of claims 26-28, further comprising a band-pass filter optically coupled between an output of the atomic vapor cell and the first and/or second outputs.

30. The photon source of any one of claims 26-28, further comprising a liquid crystal retardation plate optically coupled between an output of the atomic vapor cell and the second output.

31. The photon source of any one of claims 1-30, further comprising:
a first laser source configured to generate the first laser beam; and
a second laser source configured to generate the second laser beam.

32. The photon source of any one of claims 1-31, wherein the alkali atomic species comprises rubidium.

33. A method of generating an entangled pair of photons from an atomic vapor cell comprising atoms of an alkali atomic species, the alkali atomic species comprising a first energy level, a second energy level having a higher energy than the first energy level, and a third energy level having a higher energy than the second energy level, the method comprising:
generating a first laser beam using a first laser, the first laser beam having a first wavelength configured with a first detuning relative to a first atomic transition in the alkali atomic species, the first atomic transition being between the first energy level and the second energy level;
generating a second laser beam using a second laser, wherein the second laser beam has a second wavelength configured with a second detuning relative to a second atomic transition in the alkali atomic species, the second atomic transition being between the second and third energy levels, and the second detuning being based at least in part on the first detuning;
causing, by steering the first and second laser beams through a same region of the atomic vapor cell, a four-wave mixing process in the atoms; and
generating, as a result of the four-wave mixing process, the entangled pair of photons.

34. The method of claim 33, wherein steering the first and second laser beams through the same region of the atomic vapor cell comprises causing the first and second laser beams to be co-propagating through the atomic vapor cell.

35. The method of claim 33 or 34, wherein generating the first laser beam comprises generating the first laser beam with a first wavelength configured with a first detuning that is greater than a one-photon resonant Doppler broadening of the alkali atomic species and less than or equal to 2π×10 GHz.

36. The method of any one of claims 33-35, wherein generating the first laser beam comprises generating the first laser beam with a first wavelength configured with a first detuning of approximately 2π×1 GHz.

37. The method of any one of claims 33-35, wherein generating the first laser beam comprises generating the first laser beam with a first wavelength configured with a first detuning of approximately 2π×1.1 GHz.

38. The method of any one of claims 33-35, wherein generating the first laser beam comprises generating the first laser beam with a first wavelength configured with a first detuning of approximately 2π×1.15 GHz.

39. The method of any one of claims 33-35, wherein the first energy level is a |5S_{1/2} [symbol] state, the second energy level is a |5P_{3/2} [symbol] state, and the third energy level is a |6S_{1/2} [symbol] state.

40. The method of any one of claims 33-39, wherein generating the first laser beam having the first wavelength comprises generating the first laser beam with a first wavelength of approximately 780 nm.

41. The method of any one of claims 33-40, wherein generating the second laser beam comprises generating the second laser beam with a second wavelength configured with a second detuning that is a two-photon detuning and is larger than a double-resonant Doppler broadening of the alkali atomic species and less than or equal to 2π×10 GHz.

42. The method of any one of claims 33-41, wherein generating the second laser beam comprises generating the second laser beam with a second wavelength configured with a second detuning of approximately 2π×2 GHz.

43. The method of any one of claims 33-41, wherein generating the second laser beam comprises generating the second laser beam with a second wavelength configured with a second detuning of approximately 2π×2.4 GHz.

44. The method of any one of claims 33-43, wherein generating the second laser beam comprises generating the second laser beam with a second wavelength of approximately 1367 nm.

45. The method of any one of claims 33-44, wherein generating the first laser beam and/or generating the second laser beam comprises generating a laser beam having a power of approximately 5 mW.

46. The method of any one of claims 33-45, wherein generating the first laser beam and/or generating the second laser beam comprises generating a laser beam having a beam diameter of approximately 50 μm.

47. The method of any one of claims 33-46, wherein causing the four-wave mixing process in the atoms causes the atomic vapor cell to output bichromatic entangled pairs of photons.

48. The method of claim 47, wherein the bichromatic entangled pairs of photons each comprise a first photon and a second photon, wherein the first photon and the second photon have different wavelengths.

49. The method of claim 48, wherein the first photon has a wavelength compatible with telecommunications technology.

50. The method of claim 48 or 49, wherein the first photon has a wavelength in a range from 1300 nm to 1600 nm.

51. The method of any one of claims 48-50, wherein the first photon has a wavelength that is approximately 1324 nm.

52. The method of any one of claims 48-51, wherein the first photon has a wavelength that is approximately 1324 nm, 1367 nm, 1479 nm, or 1529 nm.

53. The method of any one of claims 48-52, wherein the second photon has a near-infrared (NIR) wavelength.

54. The method of any one of claims 48-53, wherein the second photon has a wavelength in a range from 700 nm to 925 nm.

55. The method of any one of claims 48-54, wherein the second photon has a wavelength of approximately 795 nm.

56. The method of any one of claims 48-54, wherein the second photon has a wavelength of approximately 795 nm or 780 nm.

57. The method of any one of claims 48-56, further comprising detecting the second photon using a single photon detector such that first photon is output as a heralded single photon.

58. The method of claim 57, further comprising filtering the first photon using a Fabry-Perót etalon.
